(19) United States
(12) Patent Application Publication
(10) Pub. No.: US 2022/0221852 A1
(43) Pub. Date: Jul. 14, 2022

(54) METHOD AND ARCHITECTURE FOR EMBRYONIC HARDWARE FAULT PREDICTION AND SELF-HEALING

(71) Applicant: University of Louisiana at Lafayette, Lafayette, LA (US)

(72) Inventors: Kasem KHALIL, Lafayette, LA (US); Omar Eldash, Lafayette, LA (US); Ashok Kumar, Lafayette, LA (US); Magdy Bayoumi, Lafayette, LA (US)

(73) Assignee: University of Louisiana at Lafayette, Lafayette, LA (US)

(21) Appl. No.: 17/575,982

(22) Filed: Jan. 14, 2022

Related U.S. Application Data
(60) Provisional application No. 63/137,222, filed on Jan. 14, 2021.

(51) Int. Cl. G05B 23/02; H02H 1/00

(52) U.S. Cl. CPC G05B 23/0283; H02H 1/0092

(57) ABSTRACT

Disclosed herein is a method for making embryonic bio-inspired hardware efficient against faults through self-healing, fault prediction, and fault-prediction assisted self-healing. The disclosed self-healing recovers a faulty embryonic cell through innovative usage of healthy cells. Through experimentations, it is observed that self-healing is effective, but it takes a considerable amount of time for the hardware to recover from a fault that occurs suddenly without forewarning. To get over this problem of delay, novel deep learning-based formulations are utilized for fault predictions. The self-healing technique is then deployed along with the disclosed fault prediction methods to gauge the accuracy and delay of embryonic hardware.

### CROSS REFERENCE TO RELATED APPLICATIONS

This application claims priority to U.S. Provisional Application No. 63/137,222 titled “Hardware Fault Prediction and Self-Healing in Embryonic Hardware System” filed on Jan. 14, 2021.

Statement Regarding Federally Sponsored Research or Development

Not applicable.

Reference to a “Sequence Listing”, a Table, or Computer Program

Not applicable.

### Field of the Invention

The invention relates generally to the field of reducing faults in circuitry, specifically in relation to using bio-inspired hardware to predict and respond to anticipated faults in circuitry.

### BACKGROUND OF THE INVENTION

Biomedical circuits are growing in complexity as they are being used in powerful devices used in critical situations and applications. Some examples of such cases are surgeries, prosthetics, monitoring of vital signs, artificial organs, imaging, therapeutic equipment such as kidney dialysis, and diagnostics such as lab on a chip. It is expected that such biomedical circuits work efficiently and reliably, preferably without failure or downtime. Embryonic Hardware (EmHW) is a promising methodology for designing components and subsystems used in biomedical systems such as adders, multipliers, adder accumulators, Fourier-transform spectrometer, and other subsystems for Digital Signal Processing (DSP). Components and subsystems designed using EmHW are ideally expected to be highly efficient and capable of self-healing. In EmHW, a cell is configured with certain properties and functionalities, and the same cellular configuration is extended to implement a set of functions in a process called differentiation. Each cell can perform the same set of functionalities. This allows the system to replace faulty cells and interchange them with healthy cells whenever needed.

An EmHW structure implements a function through an array of active cells and spare cells. In case some active cells fail, spare cells are used to replace the faulty cells in a similar way as in the biological recovery of stem cells to guarantee the desired performance. The general EmHW cellular structure has six components/modules: control module, input/output module, address module, a configuration module, detection module, and function module. As shown in FIG. 1, the control module monitors and controls the operations of a cell, considering its states, such as fault case, idle case, and transparent case. The input/output (I/O) module is utilized to transmit a signal between cells. The address module determines data (gene information) from its location coordinate information, and it determines the locations of the cells. The configuration module is used to store the configuration information of the whole cells, which is similar to DNA in biological cells. It is also used to provide information for the awareness of self-repair to provide self-healing. The detection module is used to detect cell state if it is in normal active condition or faulty condition. Finally, the function module provides function or processing, which is decided by the control unit.

Although very promising, EmHW hardware systems may face failure in any hardware component, which may reduce their performance. Hardware failure may occur during the time a system is running critical, real-time tasks. Such failures may occur due to the aging of the hardware. It may also occur due to the impact of the surrounding conditions such as temperature, humidity, and radiation, etc. The sources causing failure can be internal to the system or external. A fault occurs when an error affects one or more hardware components of the system. An error may also propagate to the other components and produce compounded errors. A system failure occurs when an error propagates to the service interfaces and deviates the system function from an intended one. The time delay between fault activation and failure is defined as failure latency. Faults are divided into labels based on persistence, effect, boundary, and source. In the case of persistence, a fault can be a permanent situation, intermittent status, or transient. The intermittent fault situation is caused frequently but not continuously, and it is a repetitive crash of the system or device. Errors may be produced by devices or wires. A permanent fault occurs once, and then it continues. Thus it can be hypothesized as a repetitive error. The transient fault occurs only once for a short time duration, and it does not continue as a permanent fault, and the transient fault is random.

A self-healing mechanism is used for recovering faults without any human intervention, especially in places that require high-cost maintenance such as biomedical emergency and aerospace. Self-healing is defined as the ability of a system to recover faults or failures without external intervention. Self-healing and self-repairing techniques can be used interchangeably. Repairing and healing present the reintegration of recovered/fixed cells/blocks inside the system, or they can be the replacement process of faulty cells by active cells. In other words, the system is able to check to maintain and repair its operation. The self-healing of EmHW increases system reliability for working in the desired performance for a long time in a biomedical system.

Current self-healing methods depend on fault detection to do the healing. While useful, its major drawback is that by the time self-healing begins, a system already has experienced a fault, and the fault may cause a missed operation or loss of data. Therefore, the system needs to predict and recover fault early to avoid affecting performance.

The fundamental concepts in self-healing are fault, error, and failure. A fault is an abnormal physical condition in a hardware system that provides an error. An error is a manifestation of a fault in a hardware system. Failure is the inability of the system to perform its functions due to inherent errors or disorder in its environment. A failure might happen due to error propagation to the system level. Failure can also manifest as a type of communication failure because of broken wire, loosening connectors, circuit board faults, failing communication transceivers, communication timing issues, and electromagnetic interference. Hardware faults may affect system performance. EmHW can experience faults such as open-circuit, short-circuit, noise, delay faults. A self-healing of the embryonic system aims to recover EmHW, which may have any kinds of faults that are permanent faults and transient faults. The permanent fault occurs once, and it continues for a long time. It can result from stuck at one, stuck at zero, open-circuit, or short-circuit. The transient faults can be frequent, but they occur for a short time. They happen due to some reasons such as pulse skew, delay, and bit flip.

Faults can affect an EmHW's performance due to their occurrence in, and effect on, an internal module. In the presence of faults, a module may not work as intended. For example, consider the Address Coordinate module in FIG. 1. The module can deviate from its intended operations as a fault that may cause its output to float. The module, in such a case, may send data with a wrong address or direction. Another example, in the I/O module, faults may cause the module to not transmit data out to any port due to open circuit fault, which can make the module loses connection to the ports. This module may also send data via a wrong port due to the fault. Further, in the case of the Function Block module, the effect of a fault may cause an inappropriate function to be performed. The resulting inaccuracy can then propagate further in the system. In the case of the Configuration Module, faults may cause it to configure a non-desired function to the local cell. Finally, faults may cause the Controller Module to lose its control and management of other blocks. Therefore, faults in any module can decrease, or even make futile, the performance of the whole system. Once a fault has occurred, a self-healing technique is used to recover faults. Such self-healing is crucial, especially in sensitive applications such as biomedical, aircraft, and military.

The existing techniques for self-healing in EmHW are based on cell elimination regardless of the type of fault. The main challenges that these techniques face are area overhead, flexibility, scalability, and mapping the spare cells. Self-healing methods are based on using spare components to repair faulty components. A typical mechanism of existing methods is shown in FIGS. 19(a), (b), and (c). In this example, the cells in the rightmost column are used as spare cells, and 12 cells are used as active cells, as shown in FIG. 19(a). This structure can repair only four cells using the spare cells, so, it limits recovery to 25%. If the system has a faulty cell, one of the available spare cells compensates for the faulty one as shown in FIG. 19(b). In this example, cell8 is faulty, and its operation is shifted to the neighbor cell. The old neighbor cell's operation (cell9) is shifted to the neighbor spare cell. This mechanism is called cell elimination of the faulty cell. Some other methods use a column/row elimination. For the same example, the column which has a faulty cell is shifted to the next column, and the next column is shifted to the spare column, as shown in FIG. 19(c). The main drawbacks of this mechanism are area overhead and the limitation of repairing. Also, another challenge of self-healing methods is the speed of the system after recovery. For example, consider three functions F1, F2, and F3, as shown in FIG. 20(a). The implementation of the functions, in addition to spare cells, is shown in FIG. 20(b). In this example, four spare cells are used for repairing. The delay between two neighboring cells is assumed to be 1 unit. Therefore, the function of F1 has a delay of 5 units, the function of F2 has a delay of 5 units, and the function of F3 has a delay of 5 units. The main challenge is to keep the same speed or close to the original speed. The speed of the system varies depending on the location of the spare cells in the structure. Therefore, the other challenge is to map the spare cells. For the same example, it is assumed that cell2, cell4, cell8, and cell12 are faulty. These faulty cells are repaired using the four available spare cells. The speed of the system may change due to the new cells, as shown in FIG. 20(c). The delay of F1, F2, and F3 becomes seven, seven, and six, respectively. Thus, the delay has increased by two units, two units, and one unit for F1, F2, and F3, respectively. The speed of self-healing is very important and must be considered in designing a self-healing method.

There are self-healing methods known in the art. Zhai Zhang et al. previously presented a Fault-Cell Reutilization Self-Healing Strategy (FCRSS) technique which focuses on transient faults through reusing a faulty cell. (Z. Zhang, Q. Yao, Y. Xiaoliang, Y. Rui, C. Yan, and W. Youren, “A self-healing strategy with fault-cell reutilization of bio-inspired hardware,” Chin. J. Aeronautics, vol. 32, no. 7, pp. 1673-1683, 2019). Their method has two stages of self-healing: elimination and reconfiguration. During the elimination stage, the cell, which has a transient fault, is used as a transparent cell to replace the functions of the cells on the right or left side, depending on the design. In the transparent state, the cell is reconfigured to realize re-utilization of the faulty cell. This method is simulated using a 4-bit adder in a cell array of 3×4. The main challenges of the Zhang method are that the time complexity is high, it is not robust, and the area overhead is high.

Boesen et al also has suggested a self-healing approach for EmHW. (See M. R. Boesen, J. Madsen, and P. Pop, “Application-aware optimization of redundant resources for the reconfigurable self-healing eDNA hardware architecture,” in Proc. IEEE NASA/ESA Conf. Adaptive Hardware Syst., 2011, pp. 66-73). Their method is based on using spare cells for recovering faulty cells. Three techniques for distributing spare cells are used which are: 0-Faults-Anticipated (OFA), Uniform Distribution (UD), and Minimum spare-cell Distance (MD). In the OFA method, spare cells are added at the edge columns or rows. In the UD method, spare cells are distributed uniformly in the architecture. In the MD method, the distribution of spare cells is based on allowing each active cell has a neighbor spare one by distance d. If d=1, it means each cell has one spare cell by distance one cell. The main challenge of this method is area overhead and its lack of flexibility in a complex system.

Wang Youren et al. present a self-healing method of an embryonic cellular structure array (See W. Youren and Y. Shanshan, “New self-repairing digital circuit based on embryonic cellular array,” in Proc. IEEE 8th Int. Conf. Solid-State Integr. Circuit Technol., 2006, pp. 1997-1999). Their disclosed method consists of a two-dimensional cellular array and the cellular circuit is based on a Look-Up Table (LUT). Spare cells are used for recovery, and these cells are added as one column. In the case of a faulty cell, the spare column is used for recovery. The technique is tested on a multiplier case study. The drawbacks of this method are that it does not work for multiple faults and it has a high area overhead.

### DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 provides a rendering of the block diagram of the bio-inspired embryonic hardware.

FIG. 2 provides a flowchart of the disclosed method of fault prediction and self-healing in embryonic hardware.

FIG. 3 provides a block diagram of the disclosed fault prediction method using Fast Fourier Transformation (FFT) and Multilayer Perceptron (MLP).

FIG. 4 provides a block diagram of the disclosed fault prediction method using FFT and Economic Long Short-Term Memory (ELSTM).

FIG. 5 provides a block diagram of the disclosed fault prediction method using FFT, Principal Component Analysis (PCA), and ELSTM.

FIG. 6 provides a block diagram of the disclosed fault prediction method using FFT, Relative Principal Component Analysis (RPCA), and ELSTM.

FIG. 7 provides the architecture of multilayer perceptron.

FIG. 8 provides a block diagram of ELSTM.

FIG. 9 provides a bar graph of the harmonics voltage amplitude in the frequency domain in the case of no fault.

FIG. 10 provides a line graph of the voltage signal without fault in the time domain.

FIG. 11 provides a bar graph of the harmonics voltage amplitude in the frequency domain with short-circuit fault.

FIG. 12 provides a line graph of the voltage signal with short-circuit fault in the time domain.

FIG. 13 provides a graph of the performance characteristics of the PCA.

FIG. 14 provides a graph of the performance characteristics of the RPCA.

FIG. 15 provides a table of the performance of the disclosed fault prediction methods.

FIG. 16 provides a table of the hardware utilization of FFT.

FIG. 17 provides a table of the hardware utilization of PCA and RPCA.

FIG. 18 provides a table of resource utilization on hardware implementation of ELSTM.

FIG. 19(a) provides a diagram of the embryonic hardware (EmHW) self-healing mechanism where the EmHW structure has spare cell.

FIG. 19(b) provides a diagram of the embryonic hardware (EmHW) self-healing mechanism with cell elimination of faulty cell.

FIG. 19(c) provides a diagram of the embryonic hardware (EmHW) self-healing mechanism with column elimination.

FIG. 20(a) provides a diagram of the self-healing delay effect implemented functions.

FIG. 20(b) provides a diagram of the self-healing delay effect structure without fault.

FIG. 20(c) provides a diagram of the self-healing delay effect after recovery.

FIG. 21 provides a diagram of the disclosed self-healing method, wherein the striped boxes represent spare sales and remaining boxes are normal cells.

FIG. 22 provides the disclosed cell diagram.

FIG. 23 provides a block diagram of an example of fault recovery.

FIG. 24 provides a detailed diagram of the disclosed cell.

FIG. 25 provide a chart of the hardware utilization of the self-healing method disclosed.

FIG. 26 provides a line graph of the reliability performance of traditional methods known in the art at various failure rates.

FIG. 27 provides a line graph of the reliability performance of the disclosed method at various failure rates.

FIG. 28 provides a table of the MTTF performance of the disclosed method and methods known in the art.

FIG. 29 provides a chart comparison of factors of the disclosed self-healing mechanism (referred to as the “disclosed method”) as compared to other methods known in the art. [20] refers to the method disclosed in M. R. Boesen, J. Madsen, and P. Pop, “Application-aware optimization of redundant resources for the reconfigurable self-healing eDNA hardware architecture,” in Proc. IEEE NASA/ESA Conf. Adaptive Hardware Syst., 2011, pp. 66-73. [38] refers to the method disclosed in P. Prajeesh and J. Basheer, “Implementation of human endocrine cell structure on FPGA for self-healing advanced digital system,” in Proc. IEEE Int. Conf. Emerg. Technol. Trends, 2016, pp. 1-8. [39] refers to the method disclosed in M. Samie, G. Dragffy, A. M. Tyrrell, T. Pipe, and P. Bremner, “Novel bio-inspired approach for fault-tolerant VLSI systems,” IEEE Trans. Very Large Scale Integr. Syst., vol. 21, no. 10, pp. 1878-891, Oct. 2013. refers to the method disclosed in C. Wongyai, “Improve fault tolerance in cell-based evolve hardware architecture,” in Proc. IEEE Int. Conf. Adv. Comput. Sci. Inf. Syst., 2014, pp. 13-18. [41] refers to the method disclosed in K. Kahlil, O. K. Eldash, and M. Bayoumi, “A novel approach toward less overhead self-healing hardware systems,” in Proc. IEEE 60^{th} Int. Midwest Symp. Circuits Syst., 2017, pp. 1585-88.

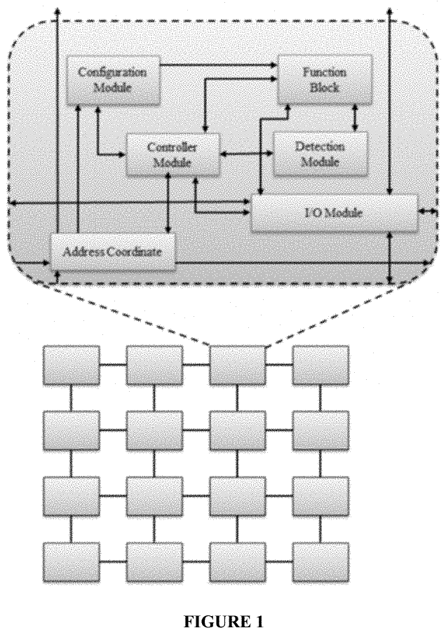

### SUMMARY OF THE INVENTION

Disclosed herein is a mechanism for self-healing, fault-prediction, and fault-prediction assisted self-healing of bio-inspired Embryonic Hardware (EmHW). The EmHW system is disclosed and validated for an arithmetic-logic unit. EmHW bio-inspired is modeled as a cellular structure for a hardware system, and it mimics the learning mechanisms from nature on providing self-repairing and self-organizing in the same manner as the cells. Designing biomedical circuits using EmHW is beneficial for supporting fault recovery and reorganizing the system to be in an optimum structure as needed.

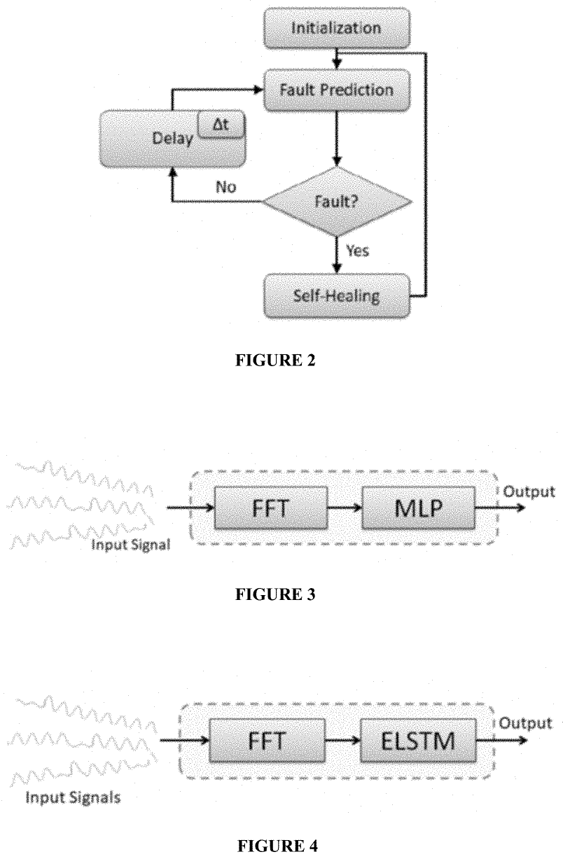

The fault prediction mechanism is part of a complete technique staring from fault prediction to self-healing without external intervention. A flow-chart showing the disclosed method is provided in FIG. 2. The system is first initialized. Then, the fault prediction mechanism checks the hardware components' status. A fault prediction process is the first stage (i.e., pre-stage) of fault recovery for self-healing methods. The benefit of early fault prediction is that it can help self-healing or fault-tolerance methods to recover the predicted fault even before the fault actually occurs or affects system performance. If there is a predicted fault, it sends the fault information to the self-healing mechanism.

The Applicant believes this disclosure to be the first disclosed method for predicting faults in EmHW. Machine learning is utilized in fault predictions. Machine learning has different structures of a neural network such as Recurrent Neural Networks (RNNs) and Convolutional Neural Network (CNN). The machine learning techniques for fault prediction of EmHW consists of four components: Fast Fourier Transform (FFT) to get the fault frequency signature, Principal Component Analysis (PCA) or Relative Principal Component Analysis (RPCA) to get the most important data with less dimension, and Economic Long Short-Term Memory (ELSTM) to learn and classify faults.

The second stage of the complete system is the self-healing method, which heals the predicted fault. The data from the fault prediction technique is utilized by the self-healing technique to recover from a fault. The self-healing technique gets the fault time and location information from the fault prediction unit and it can use this information to recover it. After repairing faults, the process repeats. In the case of no faults, the system applies the fault prediction mechanism after a certain delay At, and this time delay is tunable. The self-healing mechanism for EmHW is based on time multiplexing and two-level spare cells.

This method utilizes PCA, RPCA, and ELSTM to provide a fault prediction accuracy of more than 99 percent with lower execution time. Further, implementing the fault prediction mechanism on FPGA ensures that the method is practical, scalable, and performance is stable and robust.

### DETAILED DESCRIPTION OF THE INVENTION

The following description sets forth exemplary methods, parameters, and the like. It should be recognized, however, that such description is not intended as a limitation on the scope of the present disclosure but is instead provided as a description of exemplary embodiments.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

The present invention also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

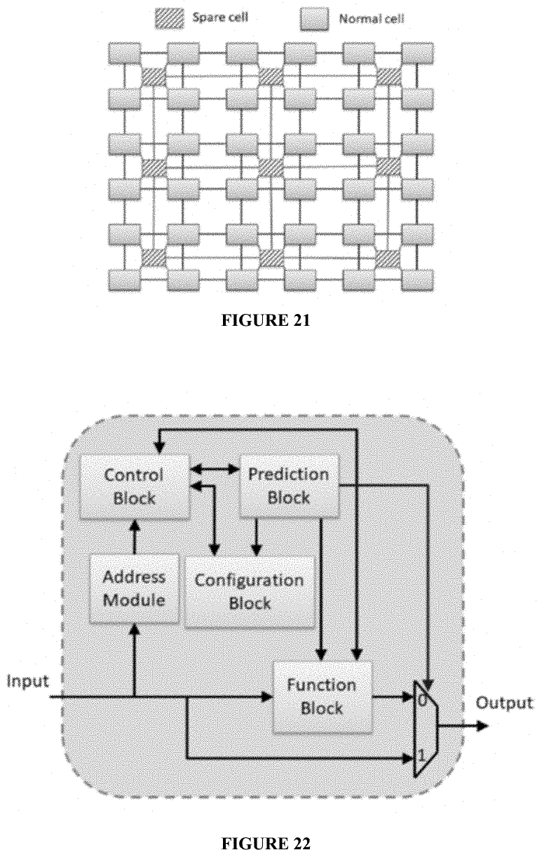

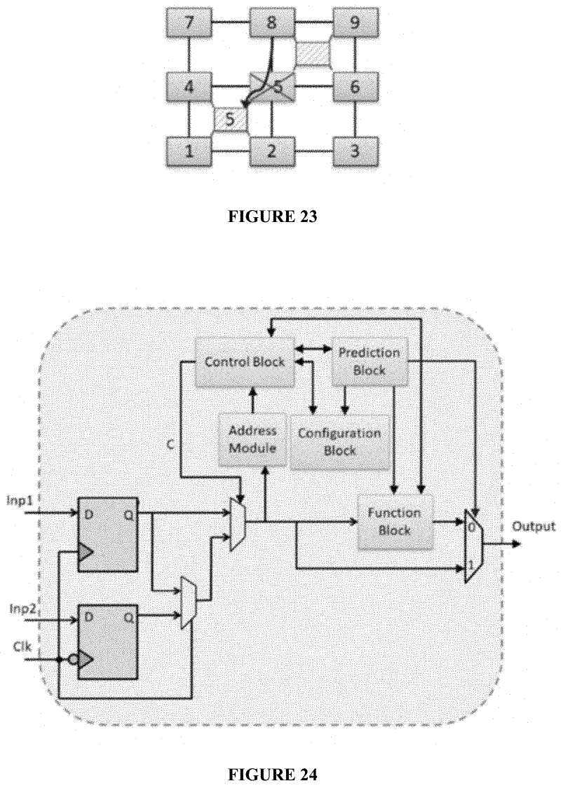

Self-Healing Mechanism. The disclosed self-healing mechanism is designed on a 2-D EmHW structure using two levels of cells. The bottom level contains the normal EmHW structure, while the upper level consists of spare cells, as shown in FIG. 21. These spare cells are used to replace the faulty ones. Every four cells have a spare one around. This provides recovery using very close neighbor cells. Therefore, the structure reorganization, and the resulted time delay are minimal. For (N×N) EmHW structure, the second level of spare cells consists of spare cells with a size of (N/2×N/2). The advantages of the disclosed are the replacement of the faulty cell is fast and the reorganization and rerouting are minimal, which reduces power consumption. The faulty cell is also used as a data pass. The disclosed cell structure is shown in FIG. 22. It includes a control block, fault prediction block, address module, configuration block, function block, and multiplexer. The fault prediction block monitors the component status. If there is no predicted fault, the prediction block outputs a value of “zero” to the multiplexer. The multiplexer passes the result of the function block to the final output. Therefore, the cell works in normal status. In the case of predicting a fault, the prediction block provides a value of “one” to the multiplexer. The multiplexer passes the original cell input to the final output. In this case, this cell is idle, but it works as a route to forward data from one cell to another, as shown in FIG. 23. The cell number 5 became faulty, and it is replaced by a spare node. The faulty cell is utilized as a route to pass data from cell8 to new cell5. The benefit of that is to reduce the rerouting processing and delay.

In one embodiment, this approach is extended to allow each active cell as a spare cell for its neighbor. Each one has the ability to perform two tasks: its task and the task of the neighbor cell. Time-Division multiplexing is used where each cell has the capacity to perform two tasks within the same clock when a fault happens, as shown in FIG. 24. One task operation is performed during the first half cycle, and the second is performed within the other half of the cycle. If the fault prediction module predicts a fault, the spare cell compensates for the future fault cell. In the case, the spare cell is already utilized, the neighbor of the faulty cell performs its task along with the task of the faulty cell. In more detail, when a fault is predicted in a cell and the nearest spare cell is not available, the neighbor cell will receive a control signal from the controller to run this faulty cell task. The active cell share execution time between its task operation and faulty cells task operation using a dual edge-triggered, which is shown in the left bottom side in FIG. 24. At the positive edge half of the clock cycle, the active cell performs its original task. A faulty task operation is performed at the half-cycle, which starts by a negative edge. Therefore, each cell has two inputs applied to a dual edge-triggered circuit, and the selection of one of them is determined by the output value of the control signal and clock (clk) value. When a fault is predicted, the control block pulls the control signal ‘C’ up for this faulty cell status. The dual edge-triggered cell drives normal input (inp1) when “clk” value increases to “one”, and it selects the faulty cell input (inp2) when “clk” value reduces from “one” to “zero”. The disclosed method provides 25% fault recovery using spare cells and 75% fault recovery for the system, including the spare cells using a multiplexing mechanism.

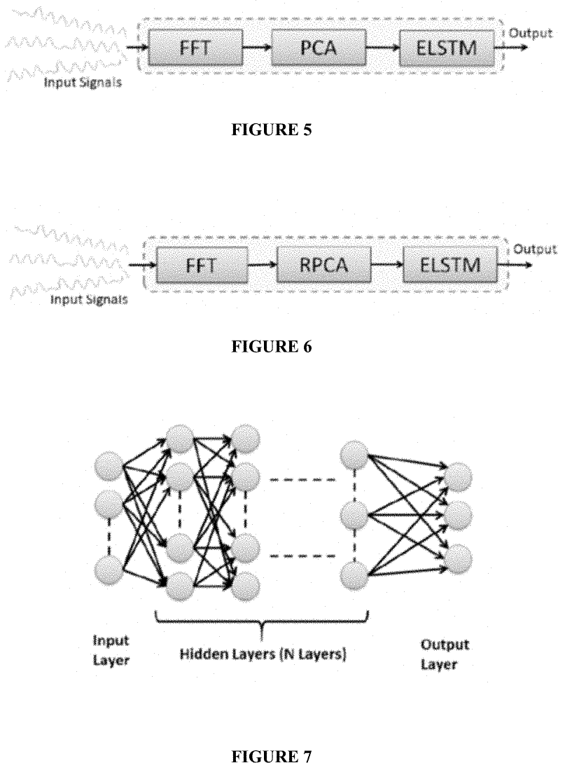

Fault Prediction Mechanism. Fault prediction is a significant process for fault recovery purposes. The mechanism may take the form of multiple embodiments, starting from a simple method to more advanced to find the most efficient method. The first embodiment comprises FFT and Multilayer Perceptron (MLP) as shown in FIG. 3. This embodiment identifies the performance using a simple structure based on MLP. FFT is used to convert the signal, which conveys fault indication, from the time to the frequency domain. The benefit of that is to get the signature of each fault in the frequency domain, where it is easy to perform it in the frequency domain. The MLP is used for classification. In another embodiment, the fault prediction mechanism further comprises FFT and ELSTM blocks, as shown in FIG. 4. The stage of ELSTM method is used for data classification (faulty or nonfaulty). This method is more economical in terms of hardware area, power consumption, and training compared to traditional methods such as LSTM, coupled-gate LSTM, Minimal Gated Unit, and Gated Recurrent Unit. Therefore, this method is beneficial in terms of hardware cost. An additional embodiment comprises FFT, PCA, and ELSTM as shown in FIG. 5. The advantage of using PCA is to reduce the resulted FFT data to reduce the training complexity of the ELSTM stage. The result of PCA includes the most important data for classification. A further embodiment comprises FFT, RPCA, and ELSTM components, as shown in FIG. 6. The RPCA is used for data reduction the same as PCA, but RPCA is based on relative weight to get more accurate data than PCA. The description of each stage in the disclosed method will now be described.

Dataset. The various embodiments of the fault prediction mechanism have been tested using the extracted data from EmHW system. The dataset includes the signal variation of the I/O module, address module, a configuration module, control module, and function module. The parameters which are used for fault prediction are voltage, current, noise, delay, and temperature. These parameters are studied on EmHW to know the system behavior with these parameters versus aging, open-circuit, and short-circuit faults. Electromigration and Stress migration are some sources for open and short circuits faults. Electromigration is caused due to the intense stress of current density. Electromigration leads to a sudden delay increase, open, or short faults. The electromigration issue happens in the interconnection, and it can be described as the physical displacement of the ions of metal in the wires' interconnection. This displacement results due to the effect of a large flow of electronics (this is called a large current density mechanism) that interacts with the metal ions. Voids and hillocks happen due to this movement, and this phenomenon produces short or open circuits connections. As the electromigration is accelerated close to the metal grain boundaries, contact holes and vias become susceptible to this impact. Stress migration occurs because of excessive structural stress. This phenomenon is similar to electromigration, wherein it leads to a sudden delay increase, short, or open faults. In this behavior, the metal atoms migrate in the interconnects due to mechanical stress, which is similar to electromigration. The stress migration is resulted by thermo-mechanical stresses that are originated by different rates of thermal expansion of different materials. The final data has 15230 samples, and it includes 550 samples for the non-faulty state. The dataset is generated in-house and used for training and testing the disclosed method. For testing, the time series data is divided into segments to apply the operation. The sampling rate is done at 1 kHz, and each recording is divided into 15s segments. Thus, each segment consists of 15000 samples.

Fast Fourier Transformation Stage. FFT transfers a signal from the original domain (such as time or space) to a representation in the frequency domain, which can help diagnose or pinpoint hardware faults. Data that represents hardware faults are not sufficient to get accurate data to machine learning. Machine Learning methods need more data and accuracy to represent faults, which allows learning to be efficient. Here, FFT is used for representing fault signals in the frequency domain. The advantages of this are getting more representative data and signature of fault in the frequency domain. Each hardware fault represents itself by a unique frequency signature. The FFT is considered as one version of the Discrete Fourier Transform (DFT), but the FFT is faster.

The FFT is performed using advanced algorithms to perform the same operation as the DFT but in much less time. For instance, a DFT computation of N points in a fundamental way, using the definition, takes O(N²) arithmetic operations while the FFT computation of the same result is only O(NlogN) operations. In the disclosed fault prediction methods, the FFT output signals and the first b frequencies have been used for the feature data for the next step to PCA or RPCA where b <<number of samples. The PCA and RPCA are used to improve the diagnostic accuracy and the computational efficiency of hardware faults. Therefore, in this stage, the role of FFT is to obtain the frequency domain of the signal, which feeds the component analysis stage. For a discrete signal x_{i,n} which can be voltage, current, temperature, humidity, etc. where i=1, 2, 3, . . . , m and n=0, 1, 2, 3, . . . N−1. The FFT of this signal will be called X_{i,k} with i=1, 2, 3, . . . , m and k=0, 1, 2, 3, . . . b−1 where b is the retained harmonics size and m is the training samples size. The mathematical equations of FFT are:

$$X ( k ) = {\sum }_{n = 0}^{N - 1} x ( n ) {W}_{N}^{kn} , k = 0 , 1 , … , N - 1 \qquad ( 1 )$$

### Where

$${W}_{N} = e \frac{- j 2 π}{N} ,$$

and the transformation equation can be divided into even and odd sections.

$$\begin{matrix}X ( k ) = {\sum }_{n even} x ( n ) {W}_{N}^{kn} + {\sum }_{n odd} x ( n ) {W}_{N}^{kn} & ( 2 ) \\ X ( k ) = {{\sum }_{m = 0}}^{\frac{N}{2} - 1} x ( 2 m ) {W}_{N}^{2 km} + {{\sum }_{m = 0}}^{\frac{N}{2} - 1} x ( 2 m ) {W}_{N}^{2 km} & ( 3 )\end{matrix}$$

Using the substitution of W_{N}²=W_{N/2}, and name the first terms and the second term as H₁(k) and H₂(k), respectively.

X(k)=H₁(k)+W_{N}^{k}H₂(k). l=0,1, . . . , N−1 (4)

Where, H₁(k) and H₂(k) are the N/2 point DFTs of the sequences h₁(m) and h₂(m), respectively. H₁(k) and H₂(k) are periodic, with period N/2, therefore H₁(k+N/2)=H₁(k) and H₂(k+N/2)=H₂(k) and H₂(k+N/2)=H₂(k). In addition, the factor W_{N}^{k+N/2}=−W_{N}^{k}.

$$\begin{matrix}X ( k ) = {H}_{1} ( k ) + {W}_{N}^{k} {H}_{2} ( k ) , k = 0 , 1 , … , \frac{N}{2} & ( 5 ) \\ X ( k + \frac{N}{2} ) = {H}_{1} ( k ) - {W}_{N}^{k} {H}_{2} ( k ) , k = 0 , 1 , … , \frac{N}{2} & ( 6 )\end{matrix}$$

Where N is the number of sampling points in an output discrete signal. By these equations, the FFT transform of the input signal will be calculated to represent the signature of the fault in the frequency domain.

Component Analysis Stage. The principal component is used to reduce the data dimension with the most important data. The benefit of this stage is to reduce the training complexity and time of classification of the next stage. There are two techniques for this purpose: PCA and RPCA, which each can be used to reduce the data size of the FFT result. The result from this stage is applied to the fault classification stage, and the classification process is performed with minimum complexity.

Principal Component Analysis. We expand the data using FFT to get more fault information and the sign of each fault. Therefore, the role of PCA is to only retain the most important data. The results include important components with a lower dimension. The idea of PCA depends on converting the correlated set of sample variables to uncorrelated variables.

PCA uses orthogonal transformation to achieve this reduction. Assume a set of sample vectors x={x¹, x², x³, . . . , xⁿ} and orthogonal normalized basis Aᵢ where i=1, 2, . . . , +∞. The orthogonal basis can be written as

$${A}_{i} {A}_{k} = \{ \begin{matrix}1 & if i = k \\ 0 & if i \neq k\end{matrix} \qquad ( 7 )$$

Each sample vector can be given as an infinite superposition of basis vectors where a basis has the same dimension. The sample vector is expressed as:

$${x}^{n} = {\sum }_{i = 1}^{∞} {α}_{i}^{n} {A}_{i} \qquad ( 8 )$$

Representing the original sample approximately by finite basis vector is used in PCA to reduce the error to a minimum. Thus, the estimated sample vector of the first d basis vector will consider the first d points, and this basis can be calculated via the orthogonal basis by:

$${\hat{x}}^{n} = {\sum }_{i = 1}^{d} {α}_{i}^{n} {A}_{i} \qquad ( 9 )$$

The error depends on the difference between the original value and the estimated value. Therefore, the subtraction between Equation 8 and 9 is given by:

$$x - \tilde{x} = {\sum }_{i = 1}^{∞} {α}_{i} {A}_{i} - {\sum }_{i = 1}^{d} {α}_{i} {A}_{i} = {\sum }_{i = d + 1}^{∞} {α}_{i} {A}_{i} \qquad ( 10 )$$

From Equation 10, the error can be calculated using expectation (E) of the difference between the original and resulted value. The error can in two ways, the first being:

$$error = E [ ( x - \tilde{x} ) {( x - \tilde{x} )}^{T} ] = E \vert {\sum }_{i = d + 1}^{∞} {α}_{i}^{2} ] \qquad ( 11 )$$

The second method of calculating error can be obtained by using Equation 9, where Aᵢ^{T}x=Σₘ₌₁^{∞}Aᵢ^{T}αₘAₘ=αᵢ and x^{T}Aᵢ=Σₘ₌₁^{∞}Aₘ^{T}αₘAᵢ=αᵢ. Using these equations to substitute in Equation 9 and the result will be:

$$error = {\sum }_{i = d + 1}^{∞} {A}_{i}^{T} {XA}_{i} \qquad ( 12 )$$

Using the error value, the basis coefficients will be adjusted by the error value to become as small as possible. The error can be calculated using Equation 11 or Equation 12, where X=E[xx^{T}]. The minimum error value is obtained under constrained condition which is Aᵢ^{T}Aᵢ=1. The eigenvalue is calculated after applying the partial derivative, and the derivative result equals zero. Therefore, the eigenvalue can be calculated by:

XAᵢ=λᵢAᵢ (13)

Where λ is the eigenvalue which is used to represent the importance of each component. The minimum error value can be achieved when the basis vector is the eigenvectors of E(xx^{T}). These eigenvectors can be calculated using a scatter matrix S,

$$S = {\sum }_{i = 1}^{m} [ ( {x}_{i} - {X}_{j} ) {( {x}_{i} - {X}_{j} )}^{T} ] \qquad ( 14 )$$

The eigenvectors' values are used for representing the components. The first mode or component of the sample vectors is referred by the eigenvector which corresponds to the largest eigenvalue. The second component refers to the eigenvector which corresponds to the second largest eigenvalue, and the sequence of the other components is define in the same definition Consequently, the sample vectors go towards a lower dimension which presents the benefit of using the PCA technique to the next stage of learning.

Relative Principal Component Analysis. RPCA is another method for data size reduction. The RPCA method is used to extract more effective principal components than PCA due to uniform distribution. This technique is based on relative weight to avoid getting false information. For the purposes of explanation of RPCA, assume M is a set generated by a measurable set S with a standard deviation of a and a mean of μ. M can be presented in such a form of the compatible sets with A=Aᵢ where μ(M)=1. The entropy can be obtained by:

$$H ( A ) = {\sum }_{j = 0}^{n} μ ( {A}_{i} ) {log}_{μ} ( {A}_{i} ) \qquad ( 15 )$$

For corresponding feature A and training set A, the uncertainty level to classify set of D, is given by empirical entropy H(D). The uncertainty level to classify feature A using the condition set of D is H(D|A). The difference between H(D) and H(D|A) presents the information gain of the uncertainly of classification is given by:

g(D, A)=H(D)−H(D|A) (16)

For training dataset D, |D| is denoted to the number of the samples. The set D has L classes, and each class is given by Cₗ where l=1, 2, . . . L, and |Cₗ| is the number of samples in Cₗ

$${\sum }_{ℓ}^{L} \vert {C}_{ℓ} \vert = \vert D \vert \qquad ( 17 )$$

Assume feature A has n values; A={α₁, α₂, α₃, . . . αₙ}, and D has n values where D={D₁, D₂, D₃, . . . , Dₙ}

$${\sum }_{j = 1}^{n} \vert {D}_{j} \vert = \vert D \vert \qquad ( 18 )$$

$${D}_{j ℓ} = {D}_{j} ∀ {D}_{ℓ} \qquad ( 19 )$$

Where Dⱼₗ is the intersection of Class Cₗ and subset Dⱼ, the empirical entropy of dataset can be expressed by:

$$H ( D ) = {\sum }_{ℓ = 1}^{L} \frac{\vert {C}_{ℓ} \vert}{\vert D \vert} {log}_{2} \frac{\vert {C}_{ℓ} \vert}{\vert D \vert} \qquad ( 20 )$$

And the conditional entropy is given by:

$$H ( D \vert A ) = {\sum }_{j = 1}^{n} \frac{\vert {D}_{i} \vert}{\vert D \vert} H ( {D}_{i} ) \qquad ( 21 )$$

### From Equation 20 and Equation 21,

$$H ( D \vert A ) = {\sum }_{j = 1}^{n} \frac{\vert {D}_{i} \vert}{\vert D \vert} {\sum }_{ℓ = 1}^{L} \frac{\vert {C}_{ℓ} \vert}{\vert D \vert} {log}_{2} \frac{\vert {C}_{ℓ} \vert}{\vert D \vert} \qquad ( 22 )$$

The information gain of dataset D by feature of A, is called the corresponding relative transformation M_{A}

M_{A}=g(D.A)=J(D)−H(D|A) (23)

The process to get M_{A} is repeated for each feature to get the corresponding relative transformation Mᵢ=g(D|i). For getting the relative principal component, assume XεR^{s×f} where s is the samples number and f is the features number. The normalized value is needed and is given by:

$$\hat{X} = \frac{{X}_{s \times f} - µ ( {X}_{s \times f} )}{σ ( {X}_{s \times f} )} \qquad ( 24 )$$

$${X}^{R} = \hat{X} \times M \qquad ( 25 )$$

$${X}^{R} = [ \begin{matrix}{X}_{11} & {X}_{12} & … & {X}_{1 N} \\ {X}_{21} & {X}_{22} & … & {X}_{2 N} \\ … & … & … & … \\ … & … & … & … \\ … & … & … & … \\ {X}_{n 1} & {X}_{n 2} & … & {X}_{n N}\end{matrix} ] \times [ \begin{matrix}{M}_{1} & 0 & 0 & … & 0 \\ 0 & {M}_{2} & 0 & … & 0 \\ … & … & … & … & … \\ … & … & … & … & … \\ … & … & … & … & … \\ 0 & 0 & 0 & … & {M}_{N}\end{matrix} ] \qquad ( 26 )$$

$$= [ \begin{matrix}{X}_{11}^{R} & {X}_{12}^{R} & … & {X}_{1 N}^{R} \\ {X}_{21}^{R} & {X}_{22}^{R} & … & {X}_{2 N}^{R} \\ … & … & … & … \\ … & … & … & … \\ … & … & … & … \\ {X}_{n 1}^{R} & {X}_{n 2}^{R} & … & {X}_{nN}^{R}\end{matrix} ] \qquad ( 27 )$$

When M=I, RPCA will be equivalent to PCA. Therefore, M is beneficial to consider the relative importance of variables into account. In order to get the values of the Principal Components (PCs) of X^{R}, the correlation matrix is used which can be expressed by

ΣₓR=E{[X_{R}]^{T}[X^{R}]} (28)

Assume all eigenvalues have λ₁^{R}≥λ₂^{R}≥λ₃^{R}≥. . . , λ_{b}^{R}, we useλⱼ for the eigenvalue, and Pⱼ is the corresponding eigenvector of λⱼ

|λ^{R}I−Σₓ_{^{R}}|=0 (29)

|λxⱼ^{R}I−Σₓ_{^{R}}|Pⱼ=0,j=0, 1, 2, . . . , b (30)

A new lower dimensional matrix T_{a×m} can be obtained by:

T_{a×b}×P_{a×n} (31)

Where P_{a×m}={(P₁^{R}, P₂^{R},P₃^{R}, . . . ,P_{N}^{R}}, m is the PCs size, and Pᵢ^{R={P}₁^{R}(1), P₂^{R}(2), P₃^{R}(3), . . . , Pₙ^{R}(b)}. The selecting number of the relative principal element can be calculated using the Cumulative Percentage of Variance (CPV) which measures the variation amount selected by the first n latent variables, and where P can be choses by a user as a threshold.

$$CPV ( n ) = \frac{{\sum }_{1}^{n} {λ}_{j}^{R}}{{\sum }_{1}^{b} {λ}_{j}^{R}} \times 100 \% > P \qquad ( 32 )$$

Multilayer Perceptron (MLP). MLP is commonly used in artificial neural networks. MLP network includes multiple layers that are divided into three labeled layers. The first layer is called the input layer and the last layer is called the output layer. The layers between the input and output layers are called hidden layers. Each layer consists of multiple nodes, and each node connects to all next layer nodes. This connection line between nodes can transmit a signal from one node to another as shown in FIG. 7. The mechanism of the network is described as each input is multiplied by a weight value which is saved in node memory. An adder is used to provide a summation of the all multiplied weighted signals to feed an activation or activation function to provide the final result. The output of each node can be calculated as

$${y}_{i} = f ( {\sum }_{j = 0}^{n} {W}_{ji} * {X}_{j} + {b}_{i} ) \qquad ( 33 )$$

Where Xⱼ is the j^{th} node output in the prior layer, and n is the number of nodes, Wⱼᵢ is the node weight from j^{th} node to the i^{th} node in the proceeding layer, f is the activation function symbol, and b is the bias.

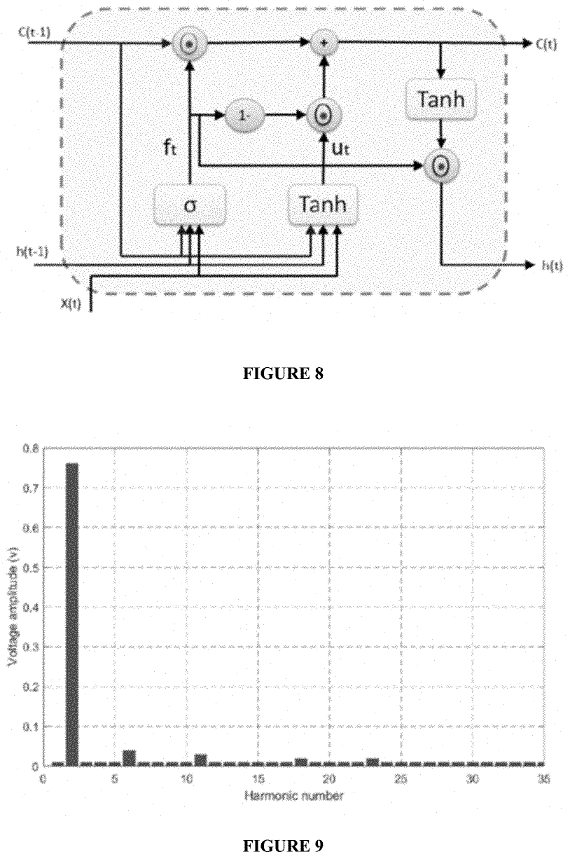

Economic LSTM Recurrent Neural Network. The ELSTM method hardware structure is shown in FIG. 8. This method has a few numbers of gates to perform a learning task with the desired performance. ELSTM is based on using one gate, and this gate performs the operations of deleting and updating. The result of this gate supplies three sections which are the memory layer, update layer, and output layer. Regarding the memory layer, using x(t), h(t −1), and c(t−1), the output result of this gate isfi which is multiplied by the memory state value c(t−1) for a forgetting process. The benefit of the gate is to couple the forget (update) gate and the input (reset) gate into one gate. The forget gate fₜ is obtained, and then subtraction is used to produce 1−fₜ. A tanh is used to provide u(t) which is resulted from xₜ, hₜ₋₁, and cₜ₋₁ and the corresponding weights. The result u(t) and 1−fₜ are multiplied by the elementwise product, and the result is added to the state memory. The memory state is used to provide accurate performance, stability, and reliability for the learning performance in terms of forgetting and updating. The mathematical description of ELSTM is defined by the following equations:

f(t)=σ(W_{f}.I_{f}+b_{f}) (34)

f(t)=σ([W_{cf},W_{xf},U_{bf}].[x(t), c(t−1), h(t−1)]+b_{f}) (35)

u(t)=tanh (Wᵤ, Iᵤ+bᵤ) (36)

u(t)=tanh ([W_{cu},Wₓᵤ,Uᵤᵤ].[x(t), c(t−1), h(t−1)]+bᵤ) (37)

C(t)=f(t) ⊙C(t−1)+(1−f(t)) ⊙U(t) (38)

h(t)=f(t) ⊙tanh (C(t)) (39)

Where I_{f} is an input in the first phase, f(t)ϵR^{d×h×r} while the width is d, the height is h, and n is the number of channels of fₜ. x(t) is the input where x(t)ϵR^{d×h×r}, and it may be for a certain issue such as fault, speech, image, and r is the number of input channels. The output of the block is h(t−1) at the time of (t−1), and the stack c(t−1) memory state represents the internal statement at the time of (t−1). In the same manner of f(t), h(t−1) and c(t−1)ϵR^{d×h×n}. The weights, W_{xf}, W_{cf}, and U_{hf} are the convolutional weights, and they have dimension size of (m×m) for all kernels. b_{f} is the bias which is a vector of a dimension n×1. Furthermore, Iᵤ is also an input for the second ELSTM stage, u(t) is the output of the update gate where u(t)ϵR^{d×h×n} and is the same dimension as fₜ. bᵤϵR^{n×1}, and has the same dimension of b_{f}ϵR^{n×1}. The weights of W_{cu}, Wₓᵤ, and Uᵤᵤ are used for update output computation. The final memory state is C(t), the final output is h(t), and the ⊙ symbol represents elementwise multiplication. ELSTM performs learning for long term history which is beneficial for fault prediction. ELSTM also has economic hardware components which reduce the computation time and power consumption.

Of the discussed embodiments, the latter two embodiments are the most efficient. The trade-offs between the two are training time and classification accuracy. These embodiments are now discussed in greater detail.

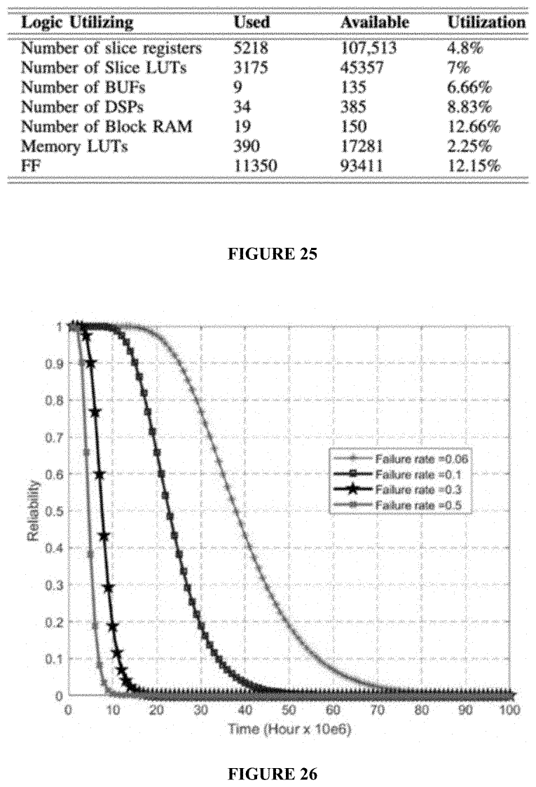

Implementation. The self-healing mechanism is implemented on FPGA. Arithmetic Logic Unit (ALU) has been implemented on EmHW to study the behavior of the disclosed method. ALU operations are used in many applications such as biomedical systems, aircraft systems, and signal processing. The EmHW is implemented using 64 cells for performing ALU operations, and the disclosed method applied. The disclosed method is implemented on Altera Arria 10GX FPGA. The disclosed method has the ability to recover 125% faulty cells, including spare cells. The area overhead is 34%, while the fault recovery is high. Thus, the disclosed method provides more age extension of EmHW. The resource consumption of the disclosed method on FPGA is shown in FIG. 25.

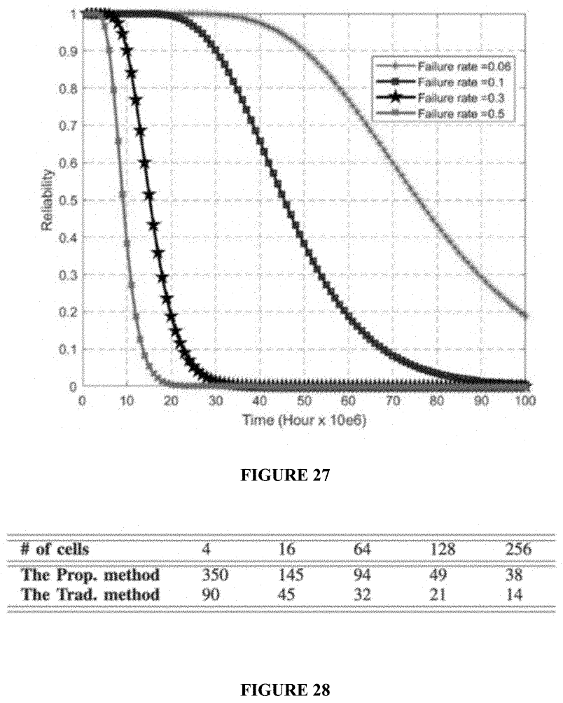

Reliability is one of the significant evaluation parameters for a self-healing technique, and it is the ability of the system to execute a function correctly within a certain time duration. The probability of success for the system can be given by p(t)=exp(−λt). Where all units are identical (all cells) in structure, and p(t) is hypothesized to be an exponential distribution failure. λ is the failure rate. Spare cells are used, and each cell also can perform two functions in the same clock period for recovering neighboring faulty cells. The system reliability is evaluated by the following equation:

$$R ( t ) = \text{?} {C}_{n}^{i} exp ( \frac{- λ it}{2} ) ( 1 - exp ( \frac{- λ t}{2} ) \text{?} \\ \text{?} \text{indicates text missing or illegible when filed} \qquad ( 40 )$$

Where n is the number of active units for m number of function. The traditional method is based on isolating the faulty component and keeping the circuit working, typically with a lower performance. For example, in a system with 16 cells, if the system has two faulty cells, the two faulty cells are isolated from the rest of the cells. Thus, the system works with only 14 healthy cells, and the performance of the system is degraded. The reliability performance for the traditional and disclosed methods using different failure rate are studied, and a comparison is presented as shown in FIG. 26 and FIG. 27, respectively. In methods known in the art, a redundancy rate of cells is used by 25%. Therefore, the system has 25% of spare cells to recover the faulty ones. The results show the reliability performance using different failure rate values of 0.06, 0.1, 0.3, and 0.5. The disclosed technique has better reliability than the conventional one, which makes it beneficial for biomedical systems. For example, at the time of 50 (hour ×10e⁶), the reliability is increased from 0.2 to 0.9 at a failure rate of 0.01. Therefore, the disclosed method improves the system's ability to execute a function for a larger time. The evaluation of system dependability is also determined by another parameter called MTTF. MTTF is defined as the whole execution time of a number component divided by the number of whole failures. MTTF also can be defined as the average time before the system fails. The MTTF value is given by:

MTTF=∫ₒ^{x}R(t)dt (41)

The analysis of the self-healing mechanism in terms of MTTF for the traditional and disclosed method is shown in FIG. 28. The result shows the disclosed method has high MTTF which indicates the age extension by disclosed method.

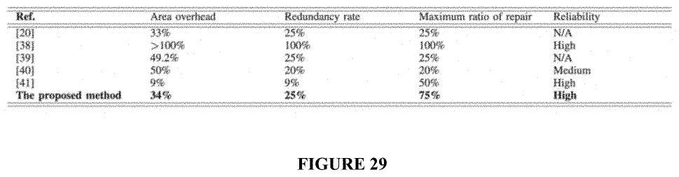

A comparison between the disclosed self-healing mechanism and the prior methods is shown in FIG. 29, in terms of area overhead, the redundancy rate, the maximum number of repair, and the reliability. The maximum number of repair refers to what is the maximum ability of the system to recover faults. The redundancy rate refers to the rate of spare cells or hardware components. Some techniques utilize redundancy to recover faults. However, the main challenges of these techniques are area overhead and the placement of the spare cells. The placement of the spare cells may affect the speed of the system after recovery. Therefore, the spare cells are needed to be placed in the optimum design to avoid a slow system. This challenge can be solved by adding spare cells by 100%, such that each cell has a spare cell. Consequently, the maximum number of repair is 100% but the area overhead will be more than 100%. Some techniques utilize a certain distribution for placement spare cells with a lower area overhead while the reliability and the recovery are low. The disclosed method achieved high reliability and the maximum recovery while the area overhead is optimum and comparable to the other methods.

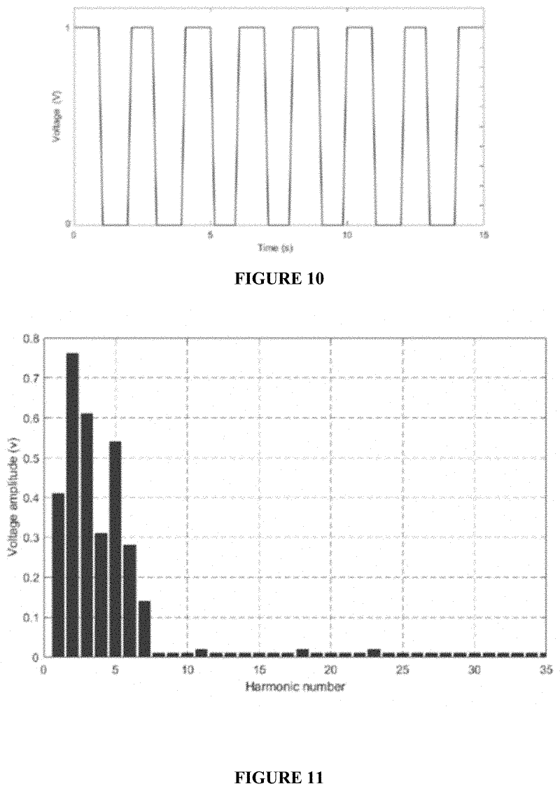

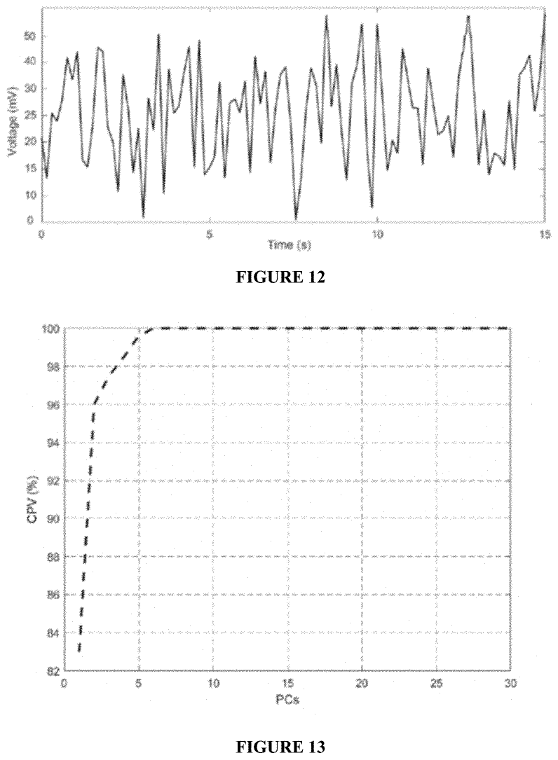

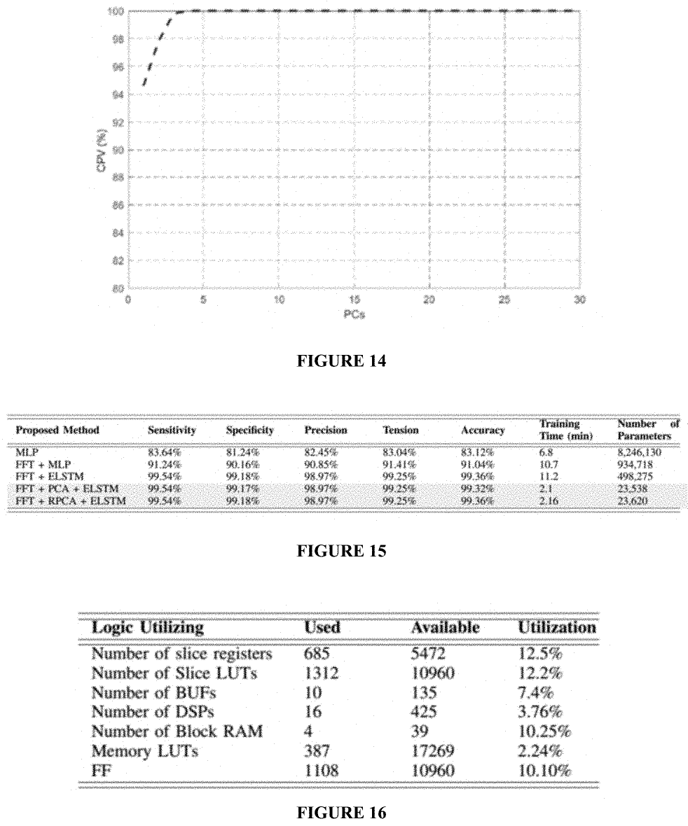

The disclosed fault prediction methods have been implemented for EmHW. The training and testing are carried on 80% of the training data which is used for the training set and 20% which is used for the validation set. The FFT process is used to extract the data and represent it in the frequency domain. The signal is converted by FFT into 0-49 harmonics using a sampling rate of 1000, and each recording is divided into 15s segments. The harmonic 0 presents the DC component of the signal. The disclosed method is tested 100 times, and the first 42 harmonics are found to be sufficient for fault diagnosis. For example, the FFT of the voltage signal in normal mode without any fault is shown in FIG. 9, and the signal in the time domain is shown in FIG. 10. On the other side, the FFT of the voltage signal in the case of short-circuit fault is shown in FIG. 11, and the signal in the time domain is shown in FIG. 12. The procedures are repeated for current, noise, delay, and temperature parameters. The FFT is the first stage of the disclosed methods. The first fault prediction method is a simple method using MLP, while the classification accuracy of this disclosed method is 83.12%. MLP is implemented by four hidden layers and one output layer. The number of units in each layer is 320, 120, 60, 20, which are ordered from the first hidden layer to the fourth one. The other disclosed methods using FFT, PCA, RPCA, and ELSTM, provide high accuracy for fault prediction as shown in FIG. 15. The principal component using PCA and RPCA has been studied. The results show the first Principal Component (PC) of PCA contains 84% of the total energy, as shown in FIG. 13. The second PC also contains 96% of the total energy, and the result will be constant after the 5^{th} PC. Therefore, we can use the first or second component for data presentation. For RPCA, the first PC contains 94.6%, and the second component contains 96.4% of the total energy, as shown in FIG. 14. The result does not change after the 4^{th} component, and it has higher performance than PCA. The parameters which are used for evaluating the disclosed methods are sensitivity, specificity, precision, tension, and accuracy. These are given by the following equations which are based on False Positives (FP), False Negatives (FN), True Positives (TP), and True Negatives (TN). The evaluation parameters are given by equations 42 through 46.

Sensitivity refers to the ratio between correct number of identified classes and the total sum of TP and FN. Sensitivity can be expressed as:

$$Sensitivity = \frac{TP}{TP + FN} \qquad ( 42 )$$

Specificity measures the proportion of actual negatives that are correctly identified.

$$Specificity = \frac{TN}{TN + FP} \qquad ( 43 )$$

Precision is the ratio between the corrected number of identified classes and the sum of the correct and uncorrected classes.

$$Precision = \frac{TP}{TP + FP} \qquad ( 44 )$$

Tension is the relation between sensitivity and precision, which should be balanced. Increasing precision results in decreasing sensitivity. Sensitivity improves with low FN, which results in increasing FP, and it reduces the precision.

$$Tension = \frac{2 * Sensitivity * Precision}{Sensitivity + Precision} \qquad ( 45 )$$

Accuracy of the test provides the ability to differentiate classes correctly.

$$Accuracy = \frac{TP + TN}{TP + TN + FP + FN} \qquad ( 46 )$$

The result shows that the MLP based method has the worst performance in terms of sensitivity, specificity, precision, accuracy, training time and a number of parameters. The low performance of this method is due to updating the network parameters without features extraction for the input. In this method, the accuracy is 83.12% and training time is 6.8 minutes with a huge number of parameters of 8,246,130 as shown in FIG. 15. The performance is improved by using FFT for feature extraction from the input data. Therefore, we disclosed the “FFT+MLP” method which provides an accuracy of 91.17% with a training time of 10.7 min and 934,718 number of parameters. The performance is improved in this method because of the ability of FFT to extract the fault features. However, the training time is increased by 4 minutes because of the computation time of FFT while the fault prediction accuracy is 91.17%. We disclosed MLP based methods to show the fault prediction performance using the traditional technique of MLP. Secondly, the disclosed method using PCA provides almost the same accuracy of 99.32% while the training time is reduced to 2.1 min. This method improved the fault prediction accuracy because of using ELSTM which is beneficial for long term temporal data. The ELSTM method is efficient in hardware cost and training process. Its execution time is low because fewer components are used. Therefore, it helps in reducing the training time. In addition, reduction in training time, also, is due to reducing the data size by PCA to get important data for training. Thirdly, the final method replaces PCA by RPCA to use relative weight to avoid any error, and it works to provide more accurate data than PCA. Therefore, this method provides the same high accuracy of 99.36% while the training time is still small at 2.16 minutes as shown in FIG. 15. The result shows the last two methods are more efficient in terms of classification accuracy and training time. In a real system, a sensor is used to get the signal from the hardware system. The sensor is used to measure the analog values, and such measuring or reading is periodic or time adjusted. These measured values are used in FFT operation for the frequency domain operations. Most biomedical systems include an in-built sensor, and thus there is little additional overhead due to measurement.

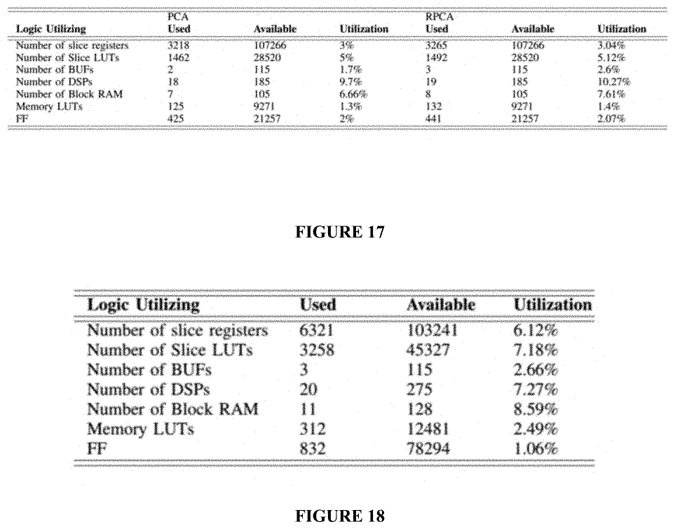

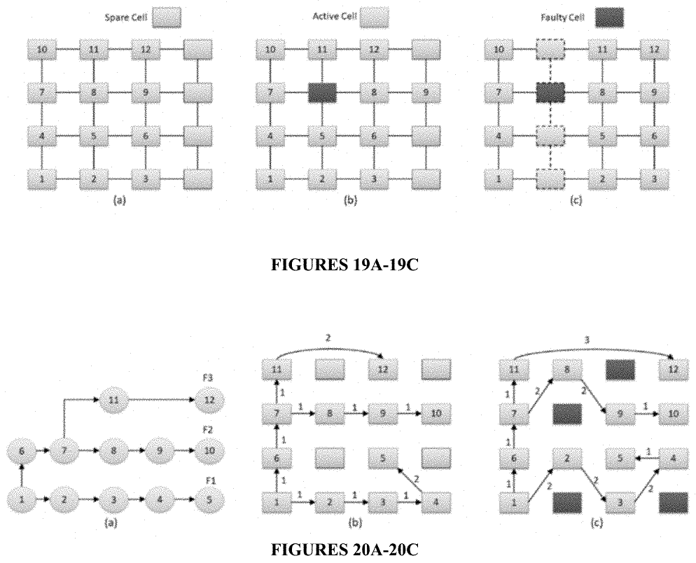

The disclosed methods have been implemented in VHDL, and Altera Arria 10 GX FPGA 10AX115N2F45E1SG using the operating frequency of 120 MHZ. The hardware resources consumption of Lookup Tables (LUTs), DSPs, Buffers, block RAM, Flip Flop (FF), etc., for each block is studied. The hardware resource consumption for implementing the FFT stage is presented in FIG. 16. These results show the used resources and their utilization, which is the ratio of used resources to the total available resources. The FFT, which is used in the system for signal processing or data acquisition, can be used for fault prediction stage. Therefore, the overhead of FFT can be negligible. The resource consumption for both PCA and RPCA are shown in FIG. 17. The RPCA has a small increase in resources compared to PCA. The learning time using RPCA is less with small overhead costs compared to PCA. The last stage of fault prediction is ELSTM, and its hardware implementation is shown in FIG. 18. The ELSTM method is power-efficient with a power consumption of 1.192 W, which is lower than the 1.847 W power consumption of LSTM. ELSTM used fewer units of components for processing, and it performed learning at a faster speed due to lower number of computation units. The entire implementation of the disclosed method consumed 1.983 W. The disclosed method provides an efficient performance with economic power consumption

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention, as described herein.

Although the description herein uses terms first, second, etc., to describe various elements, these elements should not be limited by the terms. These terms are only used to distinguish one element from another.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

This application discloses several numerical ranges in the text and figures. The numerical ranges disclosed inherently support any range or value within the disclosed numerical ranges, including the endpoints, even though a precise range limitation is not stated verbatim in the specification, because this disclosure can be practiced throughout the disclosed numerical ranges.

The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein. Finally, the entire disclosure of the patents and publications referred in this application are hereby incorporated herein by reference.

1. An architecture for a self-healing two-dimensional embryonic hardware system comprising:
at least two levels of cells, wherein each cell comprises:
a control block;
a fault prediction block;
an address module;
a configuration block;
a function block;
a multiplexer; and
connectivity means between the at least two levels of cells;
wherein at least one level of cells comprises spare cells;
wherein at least one level below the spare cells level comprises active cells; and
wherein each active cell shares a spare cell with at least one other active cell.

2. The architecture of claim 1, wherein the fault prediction block comprises functionality to monitor the system's component status.

3. The architecture of claim 1, wherein each cell is capable of performing two tasks in a single clock cycle, wherein a first task is performed in a first half cycle and a second task is performed in a second half cycle.

4. A method for self-healing a fault in a two-dimensional embryonic hardware system comprising:
(a) utilizing an embryonic hardware structure comprising of at least two levels of cells, wherein each cell comprises:
a control block;
a fault prediction block;
an address module;
a configuration block;
a function block; and
a multiplexer; and
connectivity means between the at least two levels of cells;
wherein at least one level of cells comprises spare cells;
wherein at least one level below the spare cells level comprises active cells;
wherein each active cell shares a spare cell with at least one other active cell; and
(b) the fault prediction block monitors the system's component status;
(c) when a cell fault is predicted by the fault prediction block, the fault prediction block outputs a value of one to the multiplexer, which then passes an original cell input to a final output, wherein the faulty cell is now in an idle state; and
(d) after the cell fault is detected, if no spare cell is available, a neighbor cell of the faulty cell performs a task to be performed by the faulty cell and the neighbor cell's own task in the same clock cycle.

5. The method of claim 4, further comprising when no fault is predicted by the fault prediction block, the fault prediction block outputs a value of zero to the multiplexer, and then the multiplexer passes a result of the function block to a final output.

6. The method of claim 4, further comprising where, after the cell fault is detected, if the spare cell is available, the spare cell performs the faulty cell task.

7. The method of claim 4, wherein:
(a) when after the cell fault is detected and no spare cell is available, the neighbor cell receives a control signal from the control block to run the faulty cell task;
(b) at a next clock cycle, the neighbor cell performs its original task at a positive edge half of the clock cycle; and
(c) in the same clock cycle, the neighbor cell then performs the faulty cell task at the negative edge half of the clock cycle.

8. A method for predicting fault in an embryonic hardware circuit, comprising:
(a) receiving a fault indication signal in a time domain;
(b) performing Fast Fourier Transformation of said signal to convert the fault indication signal from the time domain to a frequency domain;
(c) utilizing a multilayer perceptron (MLP) network comprising multiple layers; and
(d) classifying the fault indication signal using the MLP network.

9. The method of claim 8, wherein a first layer of the MLP network comprises an input layer, a last layer of the MLP network comprises an output layer, and one or more layers between the input layer and output later are each a hidden layer of the MLP network;
wherein each layer comprises multiple notes; and
wherein each node connects to all adjoining layer nodes through connection lines and comprise functionality to transmit signals via said connection lines.

10. The method of claim 9, wherein an output of each node can be calculated using:
$${y}_{i} = f ( {\sum }_{j = 0}^{n} {W}_{ji} * {X}_{j} + {b}_{i} )$$
wherein Xⱼ is a j^{th} node output in a prior layer, n is a total number of nodes, Wⱼᵢ is a node weight from j^{th} node to i^{th} node in a subsequent layer, f is an activation function symbol, and b is a bias.

11. A method for predicting fault in an embryonic hardware circuit, comprising:
(a) receiving a fault indication signal in a time domain;
(b) performing Fast Fourier Transformation of said signal to convert the fault indication signal from the time domain to a frequency domain; and
(c) classifying data received from the MLP network through an Economic Long Short-Term Memory (ELSTM).

12. The method of claim 11, wherein the ELSTM comprises an architecture comprising:
one gate, comprising:
at least one output;
at least three inputs comprising:
an x(t) input;
an h(t−1) input; and
a c(t−1) input;
a memory layer;
an update layer;
an output layer;
two activation functions;
one or more elementwise multiplication operations;
one or more elementwise summation operations; and
one or more weight matrices operations;
wherein the input of one activation function comprises:
the x(t) input;
the h(t−1) input; and
a c(t−1) input.

13. The method of claim 11, further comprising evaluating a principle component to reduce the size of the frequency domain data.

14. The method of claim 13, wherein the frequency domain data is reduced in size using principle component analysis (PCA), wherein orthogonal transformation is utilized to convert a correlated set of sample variables to uncorrelated variables.

15. The method of claim 13, wherein the frequency domain data is reduced in size using relative principal component analysis (RPCA).
